(19) United States
(12) Patent Application Publication
(10) Pub. No.: US 2017/0017786 A1
(43) Pub. Date: Jan. 19, 2017

(54) MEDICAL TECHNICAL DEVICE WITH NETWORK CONTROL UNIT

(71) Applicant: Fresenius Medical Care Deutschland GmbH, Bad Homburg (DE)

(72) Inventors: Jochen SIEBERT, Strahlungen (DE); Matthias KLEMENS, Dittelbrunn (DE)

(73) Assignee: Fresenius Medical Care Deutschland GmbH, Bad Homburg (DE)

(21) Appl. No.: 15/121,780

(22) PCT Filed: Mar. 23, 2015
(86) PCT No.: PCT/EP2015/056080

§ 371 Date: Aug. 26, 2016

(30) Foreign Application Priority Data
Mar. 24, 2014 (DE) 20 2014 002 535.5

(51) Int. Cl. G06F 21/34; G06F 21/60

(52) U.S. Cl. CPC G06F 21/34; G06F 21/606; G06F 2221/2149; G06F 19/3468

(57) ABSTRACT

The invention relates to medical equipment, in particular a dialysis machine, comprising an interface for exchanging data with a network. According to the invention, the interface is activated or deactivated depending on whether the medical equipment is provided with an authentication device.

The present invention relates to the field of medical technical equipment, in particular in blood treatment machines such as dialysis machines.

### BACKGROUND

Blood treatment machines are medical technical devices, in which a patient's blood is treated, often extracorporeally. Drugs may be added to the blood, for example, or blood constituents may be removed from the blood, which may be heated or cooled. For this purpose, the blood is often pumped by a blood pump outside of the patient's body, then treated and returned to the patient's body. Such a blood circulation is referred to as an extracorporeal blood circulation.

The present invention is explained below on the basis of the example of a dialysis machine as one embodiment of a medical technical device.

Additional blood treatment machines include, for example, machines for supporting heart-lung activities such as blood oxygenators or machines for supporting liver function, which remove blood toxins from the blood by adsorption. Devices for supporting liver function often combine dialysis methods with adsorption methods in one machine such as the Prometheus machine by the present applicant.

Dialysis machines are blood treatment machines in which a patient's blood is sent through a blood line to a blood treatment component, is treated by the blood treatment component and then returned to the patient through the blood line, which can be divided into an arterial branch and a venous branch. Examples of such blood treatment machines include hemodialysis machines in particular, One such blood treatment machine is the subject matter of DE 198 49 787 C1 by the present applicant, the contents of which are herewith fully included in the disclosure content of the present patent application.

Dialysis is a process for purifying the blood of patients in acute or chronic renal failure. A fundamental distinction is made here between processes such as hemodialysis, hemofiltration or hemodiafiltration, which have an extracorporeal blood circulation, and peritoneal dialysis, which does not have an extracorporeal blood circulation.

In hemodialysis, the patient's blood is passed through the blood chamber of a dialyzer, which is separated by a semipermeable membrane from a dialysis fluid chamber in an extracorporeal circulation. A dialysis fluid containing the blood electrolytes in a certain concentration flows through the dialysis fluid chamber. The substance concentration of the blood electrolytes in the dialysis fluid corresponds to the concentration in the blood of a healthy person, During the treatment, the patient's blood and the dialysis fluid are passed by both sides of the semipermeable membrane, usually in countercurrent at a predetermined flow rate. Substances that must be eliminated in urine diffuse through the membrane from the blood chamber into the chamber for dialysis fluid, while at the same time electrolytes present in the blood and in the dialysis fluid diffuse from the chamber of the higher concentration to the chamber of the lower concentration. If a pressure gradient is built up on the dialysis membrane from the blood side to the dialysate side by a pump which withdraws dialysate from the dialysate circulation downstream from the dialysis filter on the dialysate side, for example, then water is transferred from the patient's blood through the dialysis membrane and into the dialysate circulation. This process of ultrafiltration leads to the desired withdrawal of water from the patient's blood.

In hemofiltration, ultrafiltrate is withdrawn from the patient's blood by applying a transmembrane pressure in the dialyzer without passing any dialysis fluid past the side of the membrane of the dialyzer situated opposite the patient's blood, In addition, a sterile and pyrogen-free substituate solution may be added to the patient's blood. We speak of predilution or postdilution, depending on whether this substituate solution is added upstream or downstream from the dialyzer. The mass exchange takes place by convection in hemofiltration.

Hemodiafiltration combines the processes of hemodialysis and hemofiltration. A diffusive mass exchange takes place between the patient's blood and the dialysis fluid through the semipermeable membrane of a dialyzer as well as filtering of the plasma water through a pressure gradient on the membrane of the dialyzer.

The methods of hernodialysis, hemofiltration and hemodiafiltration are usually performed with automatic hemodialysis machines such as those distributed by the present applicant under the designation 5008.

Plasmapheresis is a blood treatment process in which the patient's blood is divided into the blood plasma and its corpuscular components (cells). The separated blood plasma is purified or replaced by a substitution solution, and the purified blood plasma or substitution solution is returned to the patient.

In peritoneal dialysis, a patient's abdominal cavity is filled with a dialysis fluid through a catheter passing through the abdominal wall, such that the dialysis fluid has a concentration gradient with respect to the endogenous fluids. The toxins present in the patient's body enter the abdominal cavity through the peritoneum, which acts as a membrane. After a few hours, the dialysis fluid, which is now spent dialysis fluid, in the patient's abdominal cavity is replaced. Water can be withdrawn from the patient's blood through the peritoneum into the dialysis fluid by osmotic processes, thereby withdrawing water from the patient.

The peritoneal dialysis process is usually performed with the help of automatic peritoneal dialysis machines, which are also medical technical equipment that is distributed by the present applicant under the brand name sleep.safe, for example.

Dialysis machines, as an example of complex medical technical machines, have extensive functions. To control these functions, medical fluid management machines such as dialysis machines are equipped with at least one control unit, which may be embodied as a CPU (central processing unit) or as a microcontroller programmed by software programs.

Medical technical machines are often equipped with an interface for the purpose of data exchange with a network. Such an interface may be hardwired, e.g., embodied as an R.145 data interface, or wireless, e.g., embodied as a WLAN or Bluetooth interface,

A great deal of data can be exchanged over such a data interface. For example, the software of the medical technical machine may be updated by a so-called online update by access to remote data.

In addition, treatment data such as settings, measured values for therapeutic or physiological parameters or patient data may also be sent to a remote device, for example, to a server for storage and to be made available for third parties.

In principle, there is the possibility that unauthorized data exchange takes place over the interface for data exchange with a network.

### DESCRIPTION

The object of the present invention is to create a medical technical machine, which will make data exchange with a network safer and more reliable,

According to the present invention, the solution to this problem is achieved by the medical technical machine according to claim 1.

Advantageous embodiments are the subject matter of the dependent claims.

A medical technical machine according to the teaching of the present invention includes an electronic control system and an interface for data exchange with a network. The electronic control system is understood to be any electronic circuit with the help of which the interface for data exchange can be activated or deactivated, depending on the presence of an authentication unit in the medical technical machine. Such an electronic control system may be a control unit in particular, which may be embodied as a software-programmable microcontroller or as a processor. However, the electronic control system may also be any other circuit, which serves to activate or deactivate an interface for data exchange, depending on the presence of an authentication unit in the medical technical machine.

An authentication unit in accordance with the teaching of the present invention may be a card reader. Such a card reader is equipped to input data stored on so-called smart cards and optionally also to write data to smart cards. For this purpose, smart cards have at least one data interface which may be designed, for example, as electric contact surfaces, magnetic strips or antenna configurations for receiving and transmitting radio messages.

Smart cards have a data storage device, which may be rewritable for storage of data. Such a data storage device may be, for example, a nonvolatile so-called Flash EEPROM memory, i.e., a memory that is self-sustaining with an input of power. Another embodiment which combines the interface and the memory is a magnetic strip.

Smart cards offer the possibility of authenticating their user unambiguously by storing an individual identification feature which can be retrieved by the card reader. Such an identification feature may be any combination of characters and numerals assigned to a single person. The assignment of a person to an identification feature may be stored at a central location, for example, in the medical machine.

To be sure that a certain smart card is also used by the person assigned to it [sic; to which it is assigned], a second individual character string issued only to the assigned person, for example, a secret number may be linked to the individual identification feature. The device equipped with the card reader may be configured accordingly so that after input of a smart card, the user is instructed to enter the individual character string into the device. For input and/or output of information, such a device may expediently be equipped with a touchscreen display.

The user is authenticated for a given machine by entering the correct individual character string. The machine here verifies the input on the basis of the assignment of individual identification features and individual character strings, which are already known to this machine.

Additional authentication devices may include a fingerprint scanner or an iris scanner. Both sensors utilize the measurement of biometric features of individual personal data that may be assigned to an individual person.

By means of the authentication device, the identity of the users can be determined unambiguously. For example, if the identity is not to be stored for reasons of privacy protection, then an individual recognition feature, for example, an anonymous character string, may be linked in the same way, instead of the identity of one person.

The identity as well as the individual identification feature may also be linked to authorizations. An authorization consistent with the teaching of the present invention is an item of information that can be utilized by the medical technical machine regarding which actions an authenticated user may perform on the medical machine and which actions that user may not perform. This information is linked to the identity and/or to the individual identification feature and is made known to the medical technical machine, for example, by being stored in a data memory. An authorization may also be stored on a smart card for the user together with the identity or the individual identification feature.

Authentication devices are not often standard equipment on medical technical machines. Often they are independent modules with which medical technical machines are retrofitted and into which they are integrated by assembly.

However, data interfaces are frequently part of a main circuit board and thus are often a standard part of a medical technical machine.

If a data interface is always activated, it may be used for an unauthorized data exchange with a network. For example, authorization for data exchange may require authentication of the user,

When medical technical machines are equipped with an authentication unit, these medical technical machines are often equipped so that their function depends on the authentication of the user.

In one embodiment of the invention, the interface for data exchange with a network is activated or deactivated, depending on the presence of an authentication unit in the medical technical machine.

The electronic control unit of the medical technical machine may therefore have a recognition device, configured so that the equipment of the medical technical machine is recognized by an authentication unit on the basis of the verification of at least one signal, which is generated by the equipment with the authentication unit.

Such a signal may be, for example, an electric signal, e.g., an electric voltage generated on the authentication unit when installed in the medical technical machine. Thus, for example, a card reader may be installed in such a way that it is installed in a prepared insert in the medical technical machine, and in doing so, electric contact of the control signals and power supply signals between the medical machine and the card reader is established by a contact strip.

Such a contact strip may be a plug-in card connection, for example. If the card reader is electrically connected to the medical technical machine by means of the plug-in card connection, then a contact and/or a contact face of the plug-in card connection may be connected to a voltage supplied by the medical machine by means of a corresponding electrical connection, for example. If this terminal is monitored by the recognition device, it is possible to conclude that a card reader is installed when the voltage assumes a previously defined value. In this case, the electronic controller can activate the interface for data exchange with a network.

Activation of the interface for data exchange with a network means, for example, preparing the voltage supply or establishing a connection of signal lines from the interface to the data processing device, for example, the electronic controller in accordance with the teaching of the present invention.

In another embodiment, in addition to verifying the presence of an authentication unit, a check is also performed to ascertain which authorization an authenticated user has. Many users, for example, physicians or service technicians, may be allowed to use the data interface. Patients, however, may not be allowed to use the data interface for their own safety. Depending on the authorization, data exchange over the data interface may be allowed, prevented or allowed with restrictions. A restriction on the data exchange may mean, for example, that patients receive access to certain emails over the data interface but any other data exchange is prevented for security reasons. Such permission, blockage or restriction of data exchange is implemented by corresponding software, for example, which is stored in the medical technical machine, and by an electronic controller, which is embodied as a microcontroller or processer that regulates the data exchange over the data interface and programs the data exchange.

### BRIEF DESCRIPTION OF THE FIGURES

Additional details and advantages of the invention will now be described in greater detail on the basis of exemplary embodiments depicted in the drawings, in which:

FIG. 1 shows a schematic diagram of a medical technical machine embodied as a hemodialysis machine in accordance with the teaching of the present invention, and

FIG. 2 shows a schematic diagram of a recognition device in accordance with the teaching of the present invention.

### DETAILED DESCRIPTION OF THE FIGURES

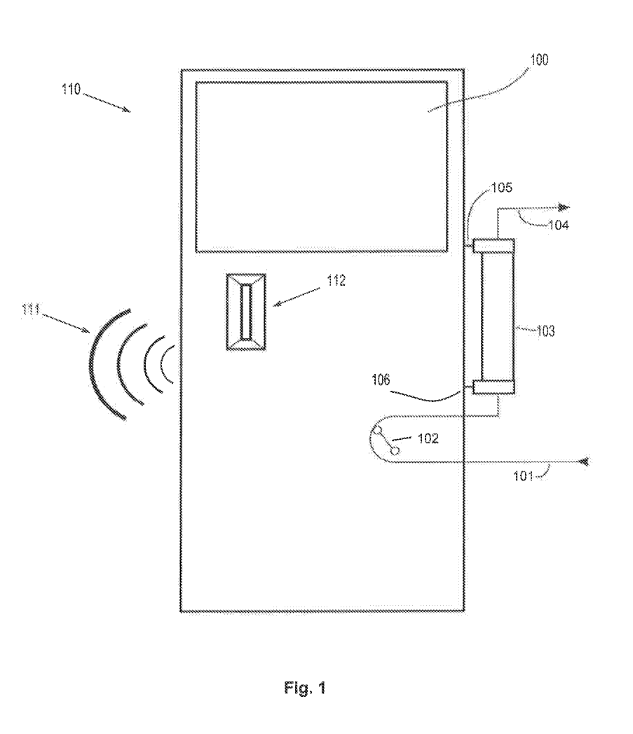

FIG. 1 shows schematically a blood treatment machine designed as a hemodialysis machine as one embodiment of a medical technical machine in accordance with the teaching of the present invention. The hemodialysis machine 110 has, as indicated, parts of an extracorporeal blood circulation with an arterial blood line 101, which drains off blood from a patient (not shown). The blood pump 102 pumps the blood through a dialysis filter 103 equipped with a semipermeable membrane, which separates the extracorporeal blood circulation from a dialysate circulation. The treated blood is returned to the patient through the venous line 104. Dialysate is pumped via the dialysate lines 105 and 106, through the dialysis filter 103, where it enters into a diffusive mass exchange with the patient's blood through the semipermeable membrane of the dialysis filter 103. Plasma water is expressed from the blood into the dialysate when a pressure gradient is also built up from the blood side of the dialysis filter to the dialysate side of the patient. Water can thus be withdrawn from the patient's blood in this way. The dialysate is prepared in the hemodialysis machine 110 and discarded after use. The blood pump 103 may be designed as a centrifugal pump or as a hose roller pump, in accordance with the teaching of the present invention.

The dialysis machine has a touchscreen display 100 for combined input and output of information. In addition the dialysis machine is equipped with an interface 111 for data exchange with a network in according with the teaching of the present invention. This interface, shown in FIG. 1 as a WLAN interface, for example, is located in the interior of the dialysis machine and symbolized by concentric segments of a circle.

In addition, the dialysis machine has an authentication unit 112 embodied as a card reader. In the case of a dialysis machine equipped in such a way, the electronic controller, which is not shown in FIG. 1, is then equipped to activate the interface 111 for data exchange with a network in accordance with the teaching of the present invention.

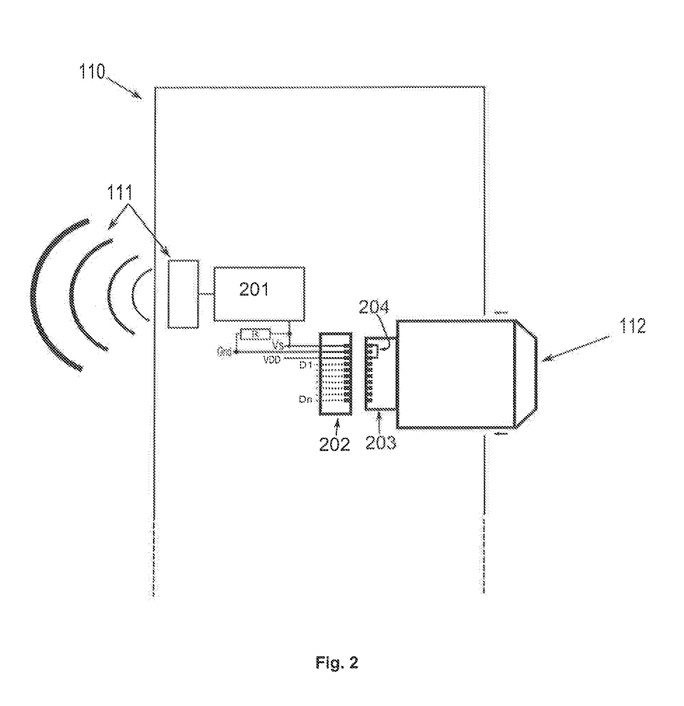

FIG. 2 shows a simplified sectional diagram of the dialysis machine 110 from FIG. 1 with an embodiment of the electronic controller in a dialysis machine in accordance with the teaching of the present invention.

The electronic controller has a control unit 201, which may be designed as a microcontroller. The electronic controller has a recognition device, which in the present exemplary embodiment consists of the contact strip 202, the power supply lines with the voltage potentials VDD and Gnd, the signal line Vs and the resistor R.

The recognition device is configured so that the potential VDD is applied to the signal line Vs when the dialysis machine 110 is equipped with an authentication unit 112. If the dialysis machine 110 is not equipped with an authentication unit 112, the potential Gnd is applied to the signal line Vs.

The contact strip 202, which is located in the interior of the dialysis machine 110, is provided for this purpose, This contact strip is, for example, a plug-in card connection for receiving plug-in cards and has a plurality of contact faces for forwarding electric signals.

In the present example, the recognition device is configured so that the signal Vs is picked up on the top contact face of the contact strip 202. The power supply potential Gnd is connected to the second contact face from above, and the power supply potential VDD is connected to the third contact face.

The contact strip 202 also has a plurality of other contact faces D1 to Dn, which may be provided for forwarding electric signals, for example, digital data.

In the present example, the card reader 112 has a plug-in card 203 with contact faces on its rear side, forming the counterpart to the contact strip 202. The plug-in card 203 and the contact strip 202 may be plugged into one another, so they fit accurately, with the opposing contact faces being connected to one another in an electrically conductive manner. The plug-in card 203 has a connecting line 204, which electrically connects the top contact face of the plug-in card 203 to the third contact face from above on the plug-in card 203.

In the embodiment of the dialysis machine 110 with the card reader 112, the card reader 112 is installed in a recess in the housing of the dialysis machine, for example, such that the plug-in card 203 is plugged into the contact strip 202, so that the opposing contact faces are connected to one another in an electrically conductive manner.

In this way, the card reader can be supplied with power through the power supply potentials VDD and Gnd, and the signals of the card reader may be made available at the contact faces D1 to Dn of the electronic controller (indicated in FIG. 2 by the dotted signal lines D1 to Dn).

Due to the fact that the plug-in card 203 and the contact strip 202 are plugged into one another as a result of assembly of the card reader 112, the power supply potential VDD is electrically connected by means of the connecting line 204 to the signal line Vs, which then assumes the potential VDD.

If there is no card reader in the dialysis machine, this electric connection is not established. The signal line Vs in this case is connected to the power supply potential Gnd across the resistor R and then assumes the potential Gnd.

The signal line Vs is electrically connected to the control unit 201. The control unit is configured to check the potential on the power supply line Vs and to deactivate the interface 111 for data exchange with a network (embodied here as a WLAN adapter) when the potential on the signal line Vs is equal to Gnd and to activate it when the potential on the signal line Vs is equal to VDD. Gnd and VDD here are equivalent to the digital signals “0” and “1.”

The activation and deactivation may be equivalent to supplying power to the interface 111 and/or to disconnecting the interface 111 from the power supply.

According to another embodiment, a check is additionally performed to ascertain the authorization of a user of the dialysis machine and, depending on this verification, to allow, prevent or allow with restrictions data exchange with a network over the interface 111.

The user's authorization is learned by readout of the smart card in the card reader by the method described above and then sent to the control unit 201, for example, over the data lines D1 to Dn (not shown in FIG. 2). The control unit 201 may be configured by appropriate programming, for example, to allow, prevent or allow with restrictions data exchange with a network over the interface 111, depending on the user's authorization.

The dialysis machine like that in FIG. 2 shows an embodiment of the invention with an authentication unit 112 embodied as a card reader and an electronic controller, which is configured only as an example and has a recognition device embodied as an example. A variety of other embodiments are also possible in accordance with the teaching of the present invention,

1. A medical technical machine comprising an electronic controller and an interface for data exchange with a network, wherein the medical technical machine is equipped for equipment with an authentication unit, and wherein the electronic controller is equipped to deactivate the interface for data exchange with a network when the medical technical machine is not equipped with an authentication unit and to activate the interface for data exchange with a network when the medical technical machine is ecwiooed with an authentication unit.

2. The medical technical machine according to claim 1, wherein the authentication unit is a card reader or a fingerprint scanner or an iris scanner.

3. The medical technical machine according to claim 1, wherein the electronic controller has a recognition device, and this recognition device is configured so that the equipment of the medical technical machine having an authentication unit is recognized on the basis of the verification of at least one signal, which is generated by the equipment with the authentication unit.

4. The medical technical machine according to claim 1, wherein the electronic controller is equipped to verify a user's authorization that has been determined by the authentication unit and to allow or to prevent or to allow with restrictions data exchange with a network on the basis of this verification.

5. The medical technical machine according to claim 1, wherein the interface for data exchange with a network is embodied as a hardwired interface, for example, as an RJ45 data interface, or may be embodied as a wireless interface, for example, as a WLAN or Bluetooth interface.

6. The medical technical machine according to claim 1, wherein the medical technical machine is a machine for treatment of blood, in particular a dialysis machine.
